(19) United States
(12) Patent Application Publication
(10) Pub. No.: US 2026/0161806 A1
(43) Pub. Date: Jun. 11, 2026

(54) TECHNIQUES TO ACCESS DEBUG AND/OR DIAGNOSTIC DATA FROM A PROCESSOR SYSTEM ON A CHIP

(71) Applicant: Intel Corporation, Santa Clara, CA (US)

(72) Inventors: Lukasz LANECKI, Gdansk (PL); Piotr MATUSZCZAK, Kawle Dolne (PL)

(21) Appl. No.: 19/433,532

(22) Filed: Dec. 26, 2025

(51) Int. Cl. G06F 21/60; G06F 21/62

(52) U.S. Cl. CPC G06F 21/602; G06F 21/604; G06F 21/6209

(57) ABSTRACT

Examples include techniques to access debug and/or diagnostics data from a processor system on a chip (SoC). Examples include circuitry of the SoC receiving a request to read debug and/or diagnostic data gathered from one or more registers maintained on the processor SoC. The examples include determining whether the debug and/or diagnostic data is protected and encrypted the gathered debug and/or diagnostic data if protected or verifying that a requester for the request is allowed to access the debug and/or diagnostic data if the debug and/or diagnostic data is not protected.

### BACKGROUND

Computing platforms or systems such as server platforms may include at least one management controller, basic input/out system (BIOS) or host operating system (OS) configured to gather debug and/or diagnostic data from a processor system on a chip (SoC). The debug and/or diagnostic data can also be referred to as telemetry data. A processor SoC can include various hardware components such as, but not limited to, processor core intellectual property (IP) blocks, processor uncore IP blocks, or IP blocks of companion dice coupled with a processor core and located on the processor SoC. An example of a management controller that gathers debug and/or diagnostic data from a processor SoC can also be referred to as a baseboard management controller (BMC). The management controller or BMC can be arranged to gather debug and/or diagnostic data from a processor SoC via use of out-of-band (OOB) communication links. Meanwhile, a BIOS or host OS for the computing platform can be arranged to gather debug and/or diagnostic data from the processor SoC via use of in-band communication links.

### BRIEF DESCRIPTION OF THE DRAWINGS

FIG. 1 illustrates an example system.

FIG. 2 illustrates an example of elements of an out-of-band management service module (OOBMSM) circuitry included in the system.

FIG. 3 illustrates an example green data process.

FIG. 4 illustrates an example red data process.

FIG. 5 illustrates an example in-band access scheme.

FIG. 6 illustrates an example out-of-band (OOB) mailbox access model.

FIG. 7 illustrates an example OOB access scheme.

FIG. 8 illustrates an example logic flow.

FIG. 9 illustrates an example storage medium.

### DETAILED DESCRIPTION

Gathering debug and/or diagnostic data from a processor SoC by a management controller, a BIOS or a host OS can include accessing debug and/or diagnostic data via OOB or in-band communication links. In some computing platforms, a management controller such as a BMC, a BIOS or host OS can gather debug and/diagnostic data from a processor SoC through a package level interface such as a Platform Environment Control Interface (PECI) routed through a single wire. According to some examples, a PECI protocol state machine (e.g., a register transfer level (RTL) block) may be included on the processor SoC to interface with the management controller, the BIOS or host OS to enable the management controller, the BIOS or host the OS to access debug and/or diagnostic data from the processor SoC. For computing platforms arranged to include server processor SoCs such as those from, but not limited to, Intel® Corporation, the PECI protocol state machine may be an out-of-band management service module (OOBMSM). A PECI crash dump mechanism is one way in which debug and/or diagnostic data for a processor SoC can be accessed through an OOBMSM. Another way to obtain debug and/or diagnostic data through an OOBMSM can be via crash logs maintained according to a monitoring technology such as, but not limited to, Intel® Platform Monitoring Technology (Intel® PMT), as described in the Intel® PMT Technical Specification, Revision 3.2, published in March 2025, herein referred to as the “PMT specification”. These crash logs may be referred to as PMT crash logs.

A PECI crash dump is typically a relatively slow way to access debug and/or diagnostic data and does not support encryption of types of data that may be considered as confidential to a designer or manufacturer of the processor SoC for which the debug and/or diagnostic data is being accessed. Also, although a PECI crash dump can allow for a type of on-demand access to debug and/or diagnostic data, legacy PECI interfaces are reaching an end of life on server computing platforms due the PECI interfaces allowing only a read to a single debug register per on-demand PECI crash dump request.

A PMT crash log may present a relatively quicker way to access debug and/or diagnostic data. However, PMT crash logs include a fixed data set and are not arranged to allow for on-demand access to debug and/or diagnostic data from a processor SoC through the OOBMSM. PMT does allow for access to debug and/or diagnostic data that is protected or confidential to a designer or manufacturer of the processor SoC in an encrypted form that can only be decrypted by the designer or manufacturer.

In addition to PECI crash dump or PMT crash log to access debug and/or diagnostic data, another method can be a test access port (TAP) debug. A TAP debug can require physically connecting a Joint Test Action (JTAG) probe to diagnose a processor SoC. This can imply that the processor SoC being diagnosed needs to be available locally and cannot be diagnosed remotely without also being available locally to physically connect the JTAG probe. Also, an unlock token needs to be provided to enable debugging.

As described in more details below, example techniques to utilize out-of-band (OOB) or in-band interfaces of OOBMSM circuitry maintained on a processor SoC can be implemented to retrieve or access debug and/or diagnostic data from the processor SoC are disclosed. The retrieved or accessed debug and/or diagnostic data can vary when it comes to how this data is classified. A user or requester for the retrieved or accessed debug and/or diagnostic data can have a desire to read a specific set of data using an application interface (API) that can allow for some definition of which debug and/or diagnostic data to retrieve or access. For data that is not confidential to a designer or manufacturer of the processor SoC, herein after referred to as “green data”, no encryption of this green data is needed. Green data can be assessed or retrieved in plain text, but an internal security mechanism can be implemented to verify whether this green data can be provided to a user/requester. For data that is confidential to the designer or manufacturer, herein after referred to as “red data”, token-based unlock and additional encryption methods can be needed to protect this sensitive red data.

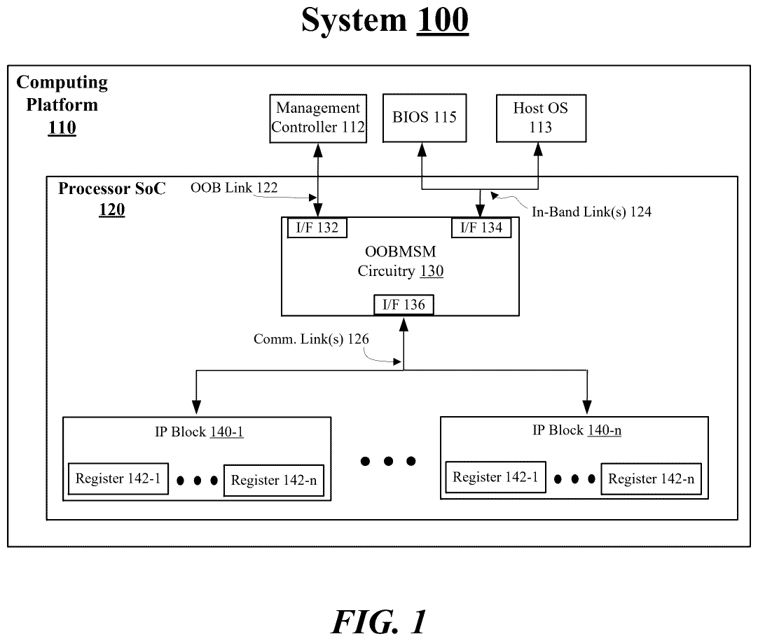

FIG. 1 illustrates an example system 100. In some examples, system 100, as shown in FIG. 1, can include a computing platform 110. Also, as shown in FIG. 1, computing platform 110 can include a processor system on a chip (SoC) 120 coupled with a management controller 112, host operating system (OS) 113, or a basic input/output operating system (BIOS) 115 through interfaces (I/Fs) maintained or configured by out-of-band management service module (OOBMSM) circuitry 130 of processor SoC 120. For example, OOBMSM circuitry 130 can include an I/F 132 arranged to couple with management controller 112 over an out-of-band (OOB) link 122 and an I/F 134 arranged to couple with BIOS 115 or host OS 113 over one or more in-band link(s) 124. OOBMSM circuitry 130 is also shown in FIG. 1 as including an I/F 136. I/F 136 can be configured to couple with intellectual property (IP) blocks 140-1 to 140-n through one or more communication link(s) 126 to access information (e.g., debug and/or diagnostic information) maintained in registers 142-1 to 142-n at IP blocks 140-1 to 140-n, where “n” is any whole positive integer greater than 1.

According to some examples, as shown in FIG. 1, OOBMSM circuitry 130 can be located on processor SoC 120. OOBMSM circuitry 130 can include a processor circuit or processor circuitry arranged to execute one or more software or firmware implemented engines, modules, agents, components, or logic to facilitate access by management controller 112, host OS 113, or BIOS 115 to debug and/or diagnostic information for SoC 120 (e.g., maintained in registers 142-1 to 142-n or respective IP blocks 140-1 to 140-n). In other examples, OOBMSM circuitry 130 may be arranged to implement these engines, modules, agents, components or logic in a manner in which is wholly or at least partially implemented in hardware or circuitry to facilitate access by management controller 112, Host OS 113, or BIOS 115 to debug and/or diagnostic information for SoC 120. OOBMSM circuitry 130 can receive communications via an out-of-band (OOB) communication link that is separate and independent from an in-band network connection for data and control packets. The OOB communication link can transfer critical alerts, management, or data, and ensure that communication stay active if the network connection is down or compromised.

In some examples, communication links(s) 126 coupled between IP blocks 140-1 to 140-n and I/F 136 of OOBMSM circuitry 130 can be a type of internal (e.g., within processor SoC 120's package) sideband network. For these examples, communication link(s) 126 can be arranged as an integrated on-chip system fabric (IOSF) or a general purpose/power management sideband (GPSB) network. IP block(s) 140-1 to 140-n may separately include one or more programmable blocks or modules of logic such as one or more field programmable gate arrays (FPGAs) or application specific integrated circuits (ASICs) arranged to support processor cores included in processor SoC 120 (processor cores are not shown in FIG. 1).

In some examples, computing platform 110 can include, but is not limited to, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof.

In some examples, processor SoC 120 can represent, either individually or collectively, various commercially available processors or processor SoCs, including without limitation processors or processor SoCs from Intel® AMD®, Nvidia®, Qualcomm®, ARM®, IBM®, Samsung® or other designers or manufactures of processors or processor SoCs.

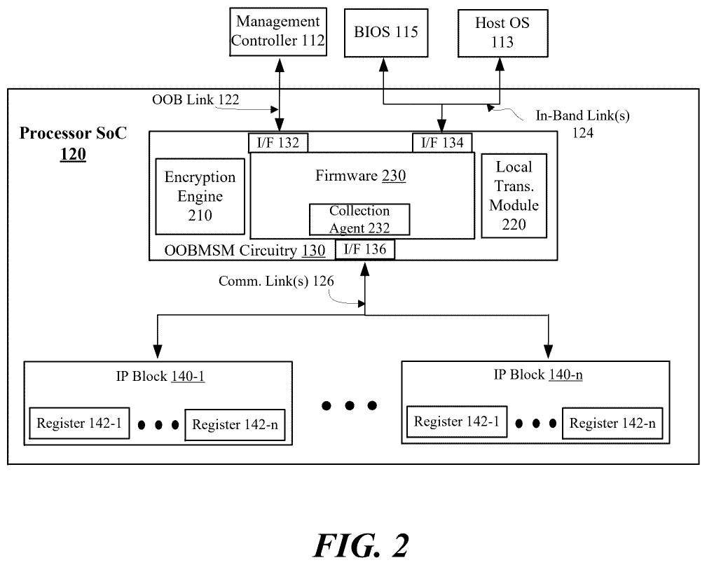

FIG. 2 illustrates an example elements of OOBMSM circuitry 130. In some examples, as shown in FIG. 2, in addition to I/Fs 132, 134 and 136, OOBMSM circuitry 130 includes an encryption engine 210, a local translation module 220, and a firmware 230. For these examples, firmware 230 can be configured to operate as firmware running in OOBMSM circuitry 130. Also, firmware 230 can implement a collection agent 220 that can collect or gather debug and/or diagnostic data through I/F 136 and over communication link(s) 126, the debug and/or diagnostic data, for example, maintained in registers 142-1 to 142-n located in one or more IP blocks 140-1 to 140-n.

In some examples, as described more below, firmware 230 can implement in-band access schemes that can enable communication with BIOS 115 or host OS 113 through I/F 134. Implementation of in-band access schemes can include use of protocols to enable communication with the BIOS 115 or host OS 113 such as protocols described in the PCI Express® (PCIe®) Base Specification, Revision 7.0, published by the Peripheral Component Interconnect Special Interest Group (PCI-SIG) on Jun. 11, 2025, hereinafter referred to as “the PCIe specification” and protocols and/or procedures described in a monitoring technology specification such as the PMT specification. For these examples, implementation of protocols and/or procedures described in the PCIe specification or the PMT specification can include firmware 230 arranged to implement a PCIe function that can expose a memory mapped input/output (MMIO) space maintained on processor SoC 120 (not shown in FIG. 2) to BIOS 115 or host OS 113 through I/F 134. The exposed MMIO space can be, for example, mapped to a type 3 PMT watcher that is discoverable via a PMT designated vender specific extended capability (DVSEC) structure as described in the PMT specification. I/F 134 can be configured to serve as a PMT application interface (API) for access or read requests received from BIOS 115 or host OS 113. The exposed MMIO space can be used to enable BIOS 115 or host OS 113 to access on-demand debug and/or diagnostic data gathered by collection agent 232 via in-band link(s) 124 and through I/F 134.

According to some examples, as described more below, firmware 230 can implement an out-of-band access scheme that can enable communication with management controller 112. The out-of-band access scheme can include use of protocols such as use of management component transport protocols (MCTPs) to encapsulate messages. The encapsulated messages according to the Platform Level Data Model (PLDM) Base Specification, Version 1.2.0 (DSP0240), published by the Distributed Management Task Force (DMTF) on Jun. 20, 2024, and the PLDM for File Transfer Specification, version 1.0.0 (DSP0242), published on Jul. 29, 2024 by the DMTF, both PLDM specifications hereinafter collectively referred to as “the PLDM specifications”. For these examples, the messages described in the PLDM specifications can include firmware 230 exchanging MCTP encapsulated messages with management controller 112 through I/F 132 according to the PLDM specifications that includes implementing a PLDM mailbox model. The PLDM mailbox model can enable management controller 112 to obtain on-demand debug and/or diagnostic data gathered by collection agent 232 via OOB link 122 and through I/F 134.

In some examples, OOBMSM circuitry 130 can be arranged to support a local translation module 220 to facilitate use of an internal SoC allowlist to check access rights associated with access to green data gathered by collection agent 232. A green data process is described below that provides an example process of how an allow list can be used by local translation module 220 to check or verify access rights for management controller 112, host OS 113 or BIOS 115 to access debug and/or diagnostic data gathered by collection agent 232 that is not confidential to a designer or manufacturer of processor SoC 120.

According to some examples, OOBMSM circuitry 130 can be arranged to support an encryption engine 210 to facilitate access to red data gathered by collection agent 232. A red data process is described below that provides an example process of how encryption engine 210 can be used to encrypt debug and/or diagnostic data gathered by collection agent 232 that is confidential to a designer or manufacturer of processor SoC 120. Hence, encryption of this red data protects the confidentiality of this red data gathered by collection agent 232.

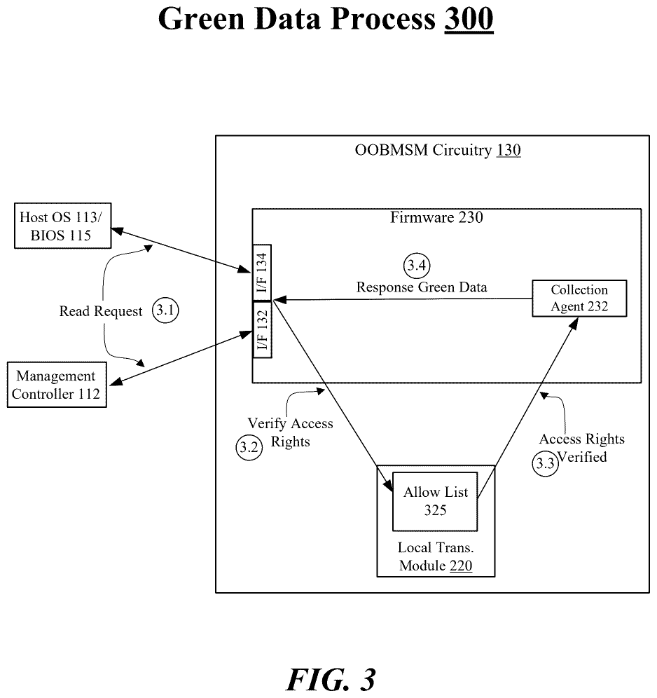

FIG. 3 illustrates an example green data process 300. In some examples, green data process 300 may be an example process of how green data can be accessed or read by host OS 113, BIOS 115 or management controller 112 using protocol or procedures dedicated to in-band access (e.g., through I/F 134) or out-of-band access (e.g., through I/F 132).

Beginning at process 3.1, host OS 113 or BIOS 115 can place a read request to access green data through I/F 132 or management controller 112 can place a read request to access green data through I/F 134. As mentioned previously, I/F 132 can be configured to serve as a PMT API to receive access or read requests from host OS 113 or BIOS 115 via in-band link(s) 124. Also, in some examples, I/F 132 can be configured according to PLDM specification to receive the read request from management controller 112 via OOB link 122. For these examples, the requests can include information to indicate what registers from among registers 142-1 to 142-n maintained in IP blocks 140-1 to 140-n of processor SoC 120 are to be accessed such as, but not limited to, a starting register address offset or a number of consecutive registers to read from among registers 142-1 to 142-n.

Moving to process 3.2, firmware 230 can be arranged to verify access rights using an allow list 325 defined or maintained by local translation module 220 to determine whether the requested read operations by host OS 113, BIOS 115 or management controller 122 are allowed.

Moving to process 3.3, firmware 230 determines that the requested read operations are allowed and access rights for host OS 113, BIOS 115 or management controller 122 are thereby verified. In some examples, access rights being verified can be based, at least in part, on allow list 325 including identifier information associated with OS 113, BIOS 115 and/or management controller 122 that was included in read or access requests.

Moving to process 3.4, firmware 230 can cause collection agent 232 to provide green data in a response to the respective read requests from host OS 113, BIOS 115 and management controller 112. The response green data can be accessed by or provided to host OS 113 or BIOS 115 through I/F 134 or accessed by or provided to management controller 112 via I/F 132. As mentioned previously, green data is for non-confidential (e.g., non-protected or unencrypted) debug and/or diagnostic data and does not expose any information that is sensitive or confidential from the point-of-view of the designer or manufacturer of processor SoC 120. Green data process 300 may then come to an end.

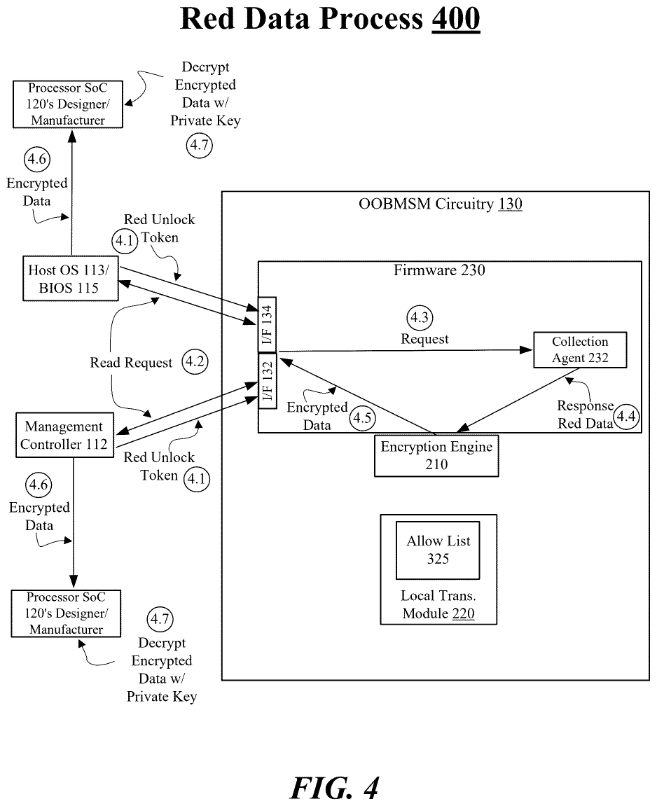

FIG. 4 illustrates an example red data process 400. In some examples, red data process 400 may be an example process of how encrypted red data can be accessed or read by host OS 113, BIOS 115 or management controller 112 using protocols or procedures dedicated to in-band access (e.g., through I/F 134) or out-of-band access (e.g., through I/F 132) and the encrypted red data sent to processor SoC 120's designer or manufacturer for eventual decryption.

Beginning at process 4.1, host OS 113, BIOS 115 and management controller 112 are to be separately required to provision a secured, cryptographic token to processor SoC 120 and/or firmware 230. The separately provisioned cryptographic tokens can serve as red unlock tokens that, if verified successfully (e.g., matching hashes), red data collection or access can be enabled for each successfully verified cryptographic token. According to some examples, firmware 230 can be configured to implement this verification process to enable red data collection.

Moving to process 4.2, host OS 113/BIOS 115 can place a read request to access red data through I/F 132 or management controller 112 can place a read request to access red data through I/F 134. As mentioned previously, I/F 132 can be configured to serve as a PMT API to receive access or read requests from host OS 113 or BIOS 115 via in-band link(s) 124. Also, in some examples, I/F 132 can be configured according to PLDM specification to receive the read request from management controller 112 via OOB link 122. For these examples, the requests can include information to indicate what registers from among registers 142-1 to 142-n maintained in IP blocks 140-1 to 140-n of processor SoC 1120 are to be accessed that include red or classified data such as, but not limited to, a starting register address offset or a number of consecutive registers to read from among registers 142-1 to 142-n.

Moving to process 4.3, since OS 113/BIOS 115 or management controller 112 have provided red unlock tokens, firmware 230 does not have to verify access rights using allow list 325 defined or maintained by local translation module 220 to determine whether the requested read operations are allowed and the request(s) to read or access the red data can be forwarded to collection agent 232.

Moving to process 4.4, collection agent 232 gathers the red data requested by host OS 113, BIOS 115 or management controller 112 and sends the gathered red data to encryption engine 210. Encryption engine 210 can be configured to encrypt the gathered red data using, for example, a symmetric cryptographic algorithm such as, but not limited to, a symmetric Advanced Encryption Standard 256-bit key (AES-256) algorithm (e.g., symmetric cryptographic algorithm). In some examples, firmware 230 can be configured to randomly generate an AES-256 key (e.g., symmetric cryptographic key) for use in the AES-256 algorithm to encrypt the red data and then wrap the randomly generated AES-256 key using an elliptic-curve cryptography (ECC) algorithm (e.g., asymmetric cryptographic algorithm) that is then attached to the encrypted red data. For these examples, a cryptographic public key for the ECC algorithm can be stored with and/or maintained by firmware 230 and the cryptographic private key can be held by processor SoC 120's designer or manufacturer. Thus, only processor SoC 120's designer or manufacturer can unwrap/decrypt the randomly generated AES-256 key to use in the AES-256 algorithm to decrypt the encrypted red data.

Moving to process 4.5, firmware 230 can cause encryption engine 210 to provide the encrypted red data in a response to the respective read requests from host OS 113, BIOS 115 or management controller 112. The response encrypted red data can be provided to or accessible by host OS 113 or BIOS 115 through I/F 134 or provided to or accessible by management controller 112 via I/F 132.

Moving to process 4.6, host OS 113, BIOS 115 or management controller 112 can send the encrypted red data to processor SoC 120's designer or manufacturer. In some examples, the encrypted red data can be sent in order for processor SoC 120's designer or manufacturer to use sensitive or classified debug and/or diagnostic information to assess and/or improve the operation of processor SoC 120.

Moving to process 4.7, processor SoC 120's designer or manufacturer decrypts the encrypted read data with the private key held by processor SoC 120's designer or manufacturer. As mentioned previously, this protects the confidentiality of the red data as only processor SoC 120's designer or manufacturer can decrypt the encrypted red data. Red data process 400 may then come to an end.

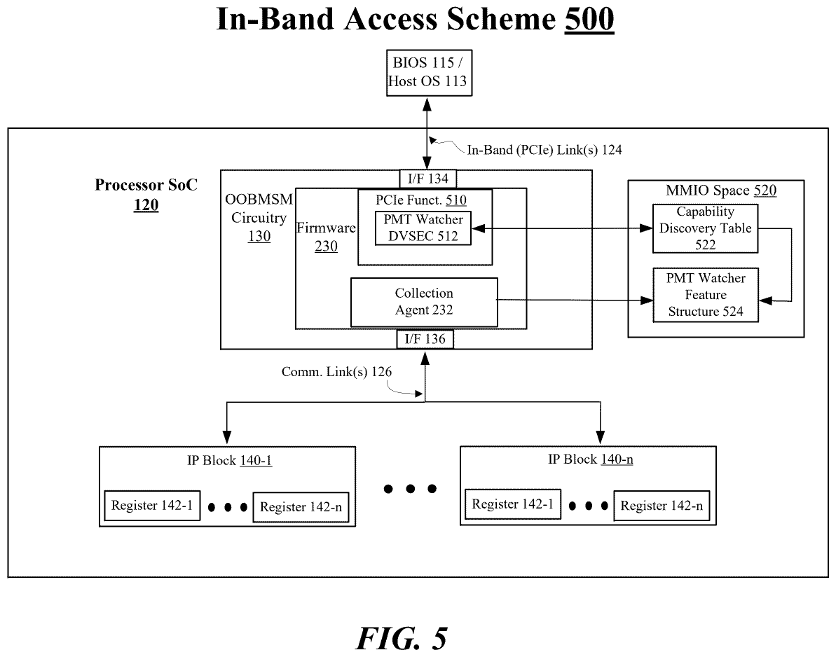

FIG. 5 illustrates an example in-band access scheme 500. According to some examples, as shown in FIG. 5, firmware 230 can be configured to implement a PCIe function 510. For these examples, PCIe function 510 can maintain a PMT watcher DVSEC 512. Watcher DVSEC 512 can represent, for example, a type 3 PMT watcher DVSEC that exposes, according to the PMT specification, a capability discovery table 522 in memory mapped I/O (MMIO) space 520 to BIOS 115 or host OS 113. Capability discovery table 522 can include information that points to where in MMIO space 520 a PMT watcher feature structure 524 is located for the type 3 PMT watcher. The type 3 PMT watcher, for example, can be included in or work in collaboration with collection agent 232 and can cause debug and/or diagnostic data to be gathered in watcher feature structure 524 maintained in MMIO space 520. In some examples, PMT watcher feature structure 524 can be configured according to the PMT specification as a type 3 PMT watcher or general purpose configuration watcher that can deliver a mailbox interface to BIOS 115 or host OS 113. The mailbox interface can provide on-demand access to either green data or encrypted red data through a PMT API routed through I/F 134 and over in-band (PCIe) link(s) 124 via access to the particular part of MMIO space 520 (e.g., PMT watcher feature structure 524) that is configured to include the green or encrypted red data. The green data or red data originating or gathered from one or more registers 142-1 to 142-n included in IP blocks 140-1 to 140-n of processor SoC 120. According to some examples, MMIO space 520 can be maintained in a memory device resident on processor SoC 120 to include a non-volatile memory device or a volatile memory device that is accessible over in-band (PCIe) link(s) 124 coupled with I/F 134 of OOBMSM circuitry 130.

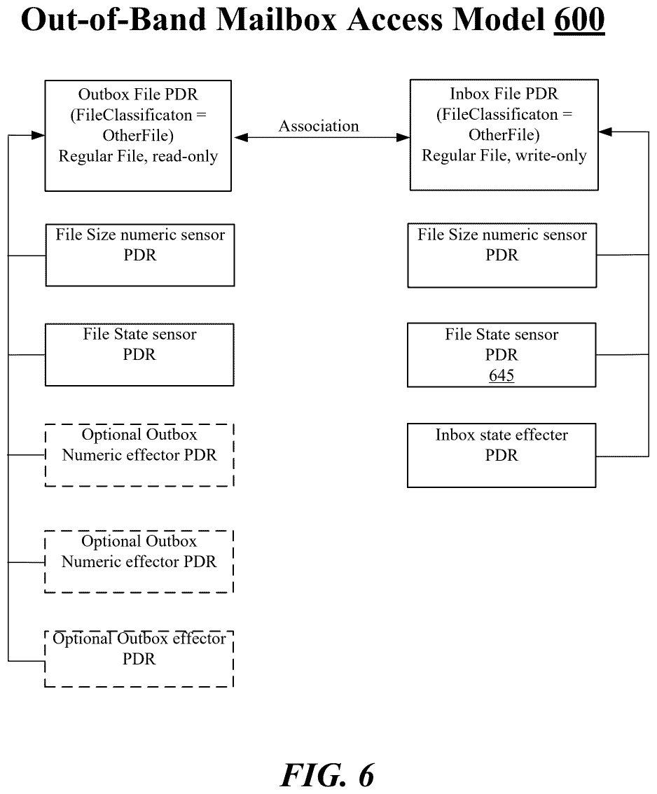

FIG. 6 illustrates an example out-of-band (OOB) mailbox access model 600. In some examples, OOB mailbox access model 600 can be implemented by management controller 112 and firmware 230 of OOBMSM circuitry 130 according to the PLDM specifications that utilize MCTP protocols to encapsulate messages. For these examples, OOB mailbox access model 600 can be implemented using two PLDM files. First, as an inbox file and second, as an outbox file. Two files can be required, because of limitations in the PLDM specifications for which a file can be opened either to read or write, but not both.

According to some examples, a file size numeric sensor shall have a maximum size set to the size of the mailbox. The file size numeric sensor can report actual data size (written to inbox file or available in outbox file). Outbox file state sensor can report “File Is Updated” state when a response is ready to be retrieved. Outbox file state sensor can generate a PLDM event to interrupt the requester when a response is ready.

In some examples, a requester can be required to write all the data to the inbox file at once (using one multipart send flow). When a XFER_COMPLETE message is sent, inbox file PDR can update its size and state sensor automatically. A DfWrite PLDM command can be limited to support a single part transfer only according to the DSP0242 PLDM specification. Multiple DfWrite commands can be required to pass all the data.

According to some examples, an inbox state effecter can be required to be set to start processing the input data, after all data is written to the inbox file. State SetId=11 (Starting, Aborted) is used to start or abort mailbox flow. When not all data was written to inbox, but state effecter was set to ‘Starting’ the response will report error.

In some examples, optional two outbox numeric effecters and one outbox state effecter can be designed to still support retrieval of debug and/or diagnostic data (e.g., crash dump records) without implementing the inbox file. These optional two outbox effecters can be implemented when the inbox file is not implemented. The first outbox numeric effecter can be used to write the address, the second outbox numeric effecter can be to provide the read length. The optional outbox state effecter can be arranged to use SetId=11 (Starting, Aborted) to start mailbox operation.

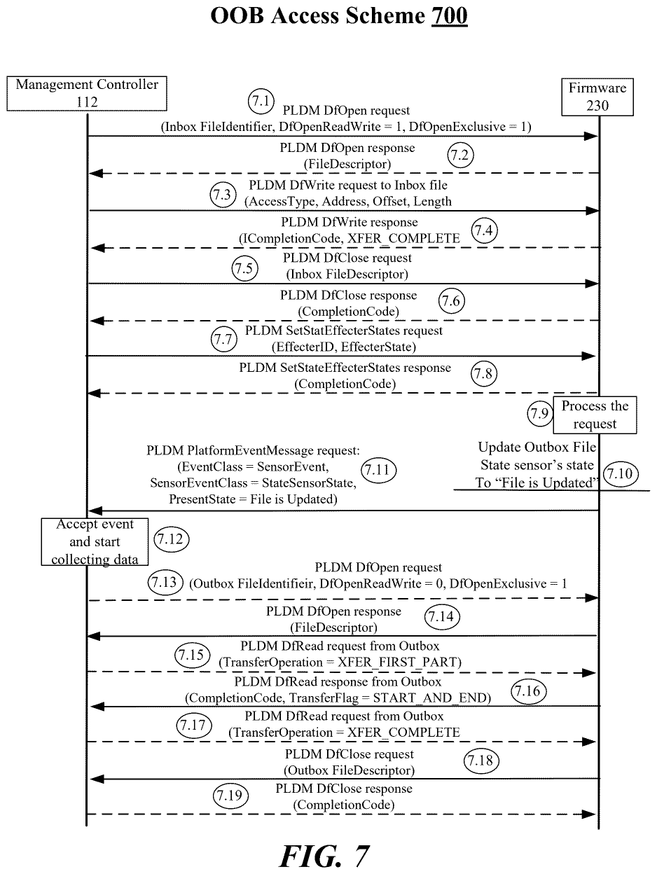

FIG. 7 illustrates an example OOB access scheme 700. According to some examples, OOB access scheme 700 can be implemented by management controller 112 and firmware 230 of OOBMSM circuitry 130 according to the PLDM specifications that utilize MCTP protocols to implement a PLDM-based simple mailbox model such as described above for OOB mailbox access model 600. For these examples, response and request messages exchanged between management controller 112 and firmware 230 can be through PLDM mailboxes that can be accessible to management controller 112 over OOB link 122 through I/F 132 as shown in FIGS. 1-2 or described above for FIGS. 1-4. OOB link 122, I/F 132 and the PLDM mailboxes can be configured according to the PLDM specifications. Also, if red data is to be accessed, out-of-band access scheme 700 begins after a red unlock token has been used to verify management controller 112 for accessing the red data as mentioned above for red data process 400.

Beginning at process 7.1, management controller 112 can cause a PLDM DfOpen request message to be sent to firmware 230. In some examples, the PLDM DfOpen request message includes an inbox file identifier, a DfOpenReadWrite=1 and a DfOpenExclusive=1 indication.

Moving to process 7.2, firmware 230 can cause a PLDM DfOpen response message to be sent to management controller 112. According to some examples, the PLDM DfOpen response message can include a file descriptor.

Moving to process 7.3, management controller 112 can cause a PLDM DfWrite request to Inbox file be sent to firmware 230. In some examples, the PLDM DfWrite request to Inbox file can include an access type, address, offset, and length to indicate to firmware 230 what access type is being made (e.g., green data or red data), information on where that access is to be made from among registers maintained in IP blocks 140-1 to 140-n and expected size of the green or red data that is to be accessed.

Moving to process 7.4, firmware 230 can cause a PLDM DfWrite response to be sent to management controller 112. According to some examples, the PLDM DfWrite response can include a completion code and an indication that the transfer is complete (XFER_COMPLETE).

Moving to process 7.5, management controller 112 can cause a PLDM DfClose request to be sent to firmware 230. In some examples, the PLDM DfClose request includes an inbox file descriptor to indicate the inbox file to close and to complete the request successfully.

Moving to process 7.6, firmware 230 can cause a PLDM DfClose response to be sent to management controller 112. According to some examples, the PLDM DfClose response can include a completion code to indicate that the inbox file has been closed.

Moving to process 7.7, management controller 112 can cause a PLDM SetStateEffecterStates request to be sent to firmware 230. In some examples, the PLDM SetStateEffecterStates request can include an effecter identifier (ID) and an effecter state to indicate to firmware 230 to begin processing the data written to the inbox.

Moving to process 7.8, firmware 230 can cause a PLDM SetStateEffecterStates response to be sent to management controller 112. According to some examples, the PLDM SetStateEffecterStates response can include a completion code to indicate that the process of the data written to the inbox has begun as requested.

Moving to process 7.9, firmware 230 can process the request that was initiated by management controller 112. In some examples, processing the request can include verifying that management controller 112 is allowed to access green data (if green data was requested) and then cause collection agent 232 to gather the green data from one or more registers 142-1 to 142-n at IP blocks 140-1 to 140-n of processor SoC 120. In other examples, if the request is to access red data, processing the request can include causing collection agent 232 to gather the red data from one or more registers 142-1 to 142-n at IP blocks 140-1 to 140-n of processor SoC 120 and can also include causing encryption engine 210 to encrypt the red data.

Moving to process 7.10, firmware 230 can update the outbox file state sensor's state to “File is Updated” to indicate that the request placed to the inbox file has been processed.

Moving to process 7.11, firmware 230 can cause a PLDM PlatformEventMessage request to be sent to management controller 112. According to some examples, the PLDM PlatformEventMessage request can indicate that an event class is a sensor event, that a sensor event class is a state sensor state, and the outbox file is in an updated state.

Moving to process 7.12, management controller 112 can accept event indicated in the PLDM PlatformEventMessage request and start to collect data (e.g., green data or encrypted red data) from the outbox file.

Moving to process 7.13, management controller 112 can cause a PLDM DfOpen request to be sent to firmware 230. In some examples, the PLDM DfOpen request can include an outbox file identifier, an indication that DfOpenReadWrite=0, and an indication that DfOpenExclusive=1.

Moving to process 7.14, firmware 230 can cause a PLDM DfOpen response to be sent to management controller 112. According to some examples, the PLDM DfOpen response can include a file descriptor.

Moving to process 7.15, management controller 112 can cause a PLDM DfRead request from Outbox to be sent to firmware 230. In some examples, the PLDM DfRead request from Outbox can indicate a first part of a transfer operation (TransferOperation =XFER_FIRST_Part).

Moving to process 7.16, firmware 230 can cause a PLDM DfRead request from Outbox to be sent to management controller 112. According to some examples, the PLDM DfRead request from Outbox can include a completion code and an a transfer flag to indicate a start and end of the transfer operation (TransferFlag=START_AND_END).

Moving to process 7.17, management controller 112 can cause a PLDM DfRead request from Outbox to be sent to firmware 230. In some examples, the PLDM DfRead request from Outbox can indicate that the transfer operation is complete (XFER_COMPLETE).

Moving to process 7.18, firmware 230 can cause a PLDM DfClose request to be sent to management controller 112. According to some examples, the PLDM DfClose request can include an outbox file descriptor to indicate the outbox file to close.

Moving to process 7.19, management controller 112 can cause a PLDM DfClose response to firmware 230. In some examples, the PLDM DfClose response can include a completion code to indicate that the outbox file has been closed. OOB access scheme 700 then comes to an end.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

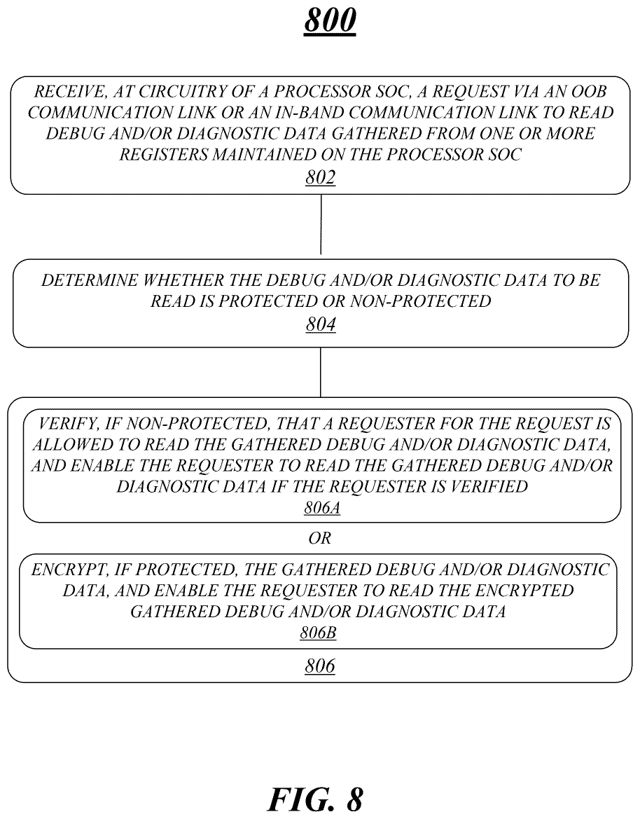

FIG. 8 illustrates an example logic flow 800. Logic flow 800 may be representative of some or all of the operations executed by circuitry of a processor SoC described herein, such as OOBMSM circuitry 130 of processor SoC 120 that can be arranged to execute firmware 230 and includes encryption engine 210, local translation module 220 and interfaces 132, 134 and 136.

According to some examples, logic flow 800 at block 802 can receive, at circuitry of a processor SoC, a request via an OOB communication link or an in-band communication link to read debug and/or diagnostic data gathered from one or more registers maintained on the processor SoC. For these examples, firmware 230 can receive the request from management controller 112 or through I/F 132 coupled with OOB link 122 or receive the request from BIOS 155/host OS 113 through I/F 134 coupled with in-band link(s) 124.

In some examples, logic flow 800 at block 804 can determine whether the debug and/or diagnostic data to be read is protected (e.g., confidential) or non-protected (e.g., non-confidential). For these examples, firmware 230 can determine whether the debug and/or diagnostic data is protected (red data) or non-protected (green data) based on whether a manufacturer or designer of processor SoC has designated the requested debug and/or diagnostic data as protected. If designated as protected, the request may involve a red data process such as red data process 400 shown in FIG. 4 and described above. If not designated as protected, the request may involve a green data process such as green data process 300 shown in FIG. 3 and described above.

According to some examples, logic flow 800 at block 806 can go to either block 806A if non-protected or to block 806B if protected. For these examples, logic flow 800 at block 806A can verify, if non-protected, that a requester for the request is allowed to read the gathered debug and/or diagnostic data, and enable the requester to read the gathered debug and/or diagnostic data if the requester is verified. Firmware 230 can use an allow list such as allow list 325 maintained by local translation module 220 to see if the requester is allowed to read or access the gathered debug and/or diagnostic data. If allowed/verified, firmware 230 can enable the requester to read the gathered debug and/or diagnostic data. Also for these examples, logic flow 800 at block 806B can encrypt, if confidential, the gathered debug and/or diagnostic data, and enable the requester to read the encrypted gathered debug and/or diagnostic data. Firmware 230 can utilize encryption engine 210 to encrypt the gathered debug and/or diagnostic data and enable the requester to read the encrypted gathered debug and/or diagnostic data.

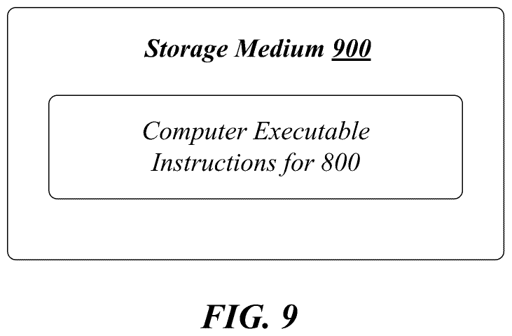

FIG. 9 illustrates an example storage medium 900. Storage medium 900 can be an article of manufacture. In some examples, storage medium 900 can include any non-transitory computer readable medium or machine readable medium, such as an optical, magnetic or semiconductor storage. Storage medium 900 can store various types of computer executable instructions, such as instructions to implement logic flow 800. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” and may be similar to IP blocks. IP cores may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, programmable logic devices (PLDs), digital signal processors (DSPs), FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled” or “coupled with”, however, may also mean that two or more elements are not in direct contact with each other, but yet still co-operate or interact with each other.

The follow examples pertain to additional examples of technologies disclosed herein.
Example 1. An example apparatus can include a first interface to couple with a first link and a second interface to couple with a second link. The apparatus can also include circuity to receive a request through the first interface or the second interface to read debug and/or diagnostic data gathered from one or more registers maintained on a processor SoC. The circuitry can also be configured to determine whether the debug and/or diagnostic data to be read is protected or non-protected. The circuitry can also, for non-protected debug and/or diagnostic data, verify that a requester for the request is allowed to read the gathered debug and/or diagnostic data and enable the requester to read the gathered debug and/or diagnostic data if the requester is verified. The circuitry can also, for protected debug and/or diagnostic data, cause the gathered debug and/or diagnostic data to be encrypted and enable the requester to read the encrypted gathered debug and/or diagnostic data.
Example 2. The apparatus of example 1, the request can be received through the first interface and the requester comprises a management controller.
Example 3. The apparatus of example 2, the first interface can be arranged to operate using management component transport protocols to encapsulate messages described in Platform Level Data Model (PLDM) specifications to include the PLDM Base Specification (DSP0240) and the PLDM for File Transfer Specification (DSP0242).
Example 4. The apparatus of example 3 can also include the circuitry to receive the request from the management controller through the first interface and to cause the management controller to read the gathered debug and/or diagnostic data through the first interface.
Example 5. The apparatus of example 1, to verify that the requester associated with the request is permitted to read the debug and/or diagnostic data can also include to access an allow list that is to specify whether the requester is permitted or not permitted to read the debug and/or diagnostic data.
Example 6. The apparatus of example 1, the request can be received through the second interface and the requester comprises a BIOS or a host OS.
Example 7. The apparatus of example 6, wherein the second interface can be arranged to operate using protocols described in the PCI Express Base Specification, Revision 7.0.
Example 8. The apparatus of example 7, to enable the BIOS or host OS to read gathered debug and/or diagnostic data can include the BIOS or host OS enabled to access a MMIO space through the second interface to read the gathered debug and/or diagnostic data.
Example 9. The apparatus of example 1, the debug and/or diagnostic data can be determined as protected based on a designer or manufacturer of the processor SoC designating the debug and/or diagnostic data as protected.
Example 10. The apparatus of example 9, a cryptographic token can be received from the requester and the cryptographic token can be used to verify the requester before the requester is enabled to read the encrypted gathered debug and/or diagnostic data.
Example 11. The apparatus of example 9, wherein the gathered debug and/or diagnostic data can be encrypted using a symmetric cryptographic algorithm based on a randomly generated symmetric cryptographic key.
Example 12. An example method can include receiving, at circuitry of a processor SoC, a request via a first link or a second link to read debug and/or diagnostic data gathered from one or more registers maintained on the processor SoC. The method can also include determining whether the debug and/or diagnostic data to be read is protected or non-protected. For non-protected debug and/or diagnostic data, the method can also include verifying that a requester for the request is allowed to read the gathered debug and/or diagnostic data, and enabling the requester to read the gathered debug and/or diagnostic data if the requester is verified. For protected debug and/or diagnostic data, the method can also include encrypting the gathered debug and/or diagnostic data and enabling the requester to read the encrypted gathered debug and/or diagnostic data.
Example 13. The method of example 12, the request can be received via the first link and the requester comprises a management controller.
Example 14. The method of example 13, the circuitry of the SoC to receive the request from the management controller can be configured to include an interface arranged to couple with the first link, the interface arranged to operate using management component transport protocols to encapsulate messages described in PLDM specifications to include the PLDM Base Specification (DSP0240) and the PLDM for File Transfer Specification (DSP0242).
Example 15. The method of example 14 can also include receiving the request from the management controller through the interface and causing the management controller to read the gathered debug and/or diagnostic data through the interface.
Example 16. The method of example 13, the circuitry can be an OOBMSM and the management controller can be a BMC.
Example 17. The method of example 12, the request can be received via the second link and the requester can be a BIOS or a host OS.
Example 18. The method of example 17, wherein the requester can be the BIOS or the host OS, and the method can also include enabling the BIOS or host OS to read gathered debug and/or diagnostic data by accessing a MMIO space maintained on the processor SoC through an interface to read the gathered debug and/or diagnostic data.
Example 19. The method of example 18, the method that includes enabling the BIOS or host OS to read gathered debug and/or diagnostic data can also include the BIOS or host OS accessing a MMIO space through the interface to read the gathered debug and/or diagnostic data.
Example 20. The method of example 12, the debug and/or diagnostic data can be determined as protected based on a designer or manufacturer of the processor SoC designating the debug and/or diagnostic data as protected.
Example 21. The method of example 20, a cryptographic token can be received from the requester and the cryptographic token can be used to verify the requester before enabling the requester to read the encrypted gathered debug and/or diagnostic data.
Example 22. The method of example 20, the gathered debug and/or diagnostic is encrypted can include data encrypted using a symmetric cryptographic algorithm based on a randomly generated symmetric cryptographic key.
Example 23. An example at least one machine readable medium can include a plurality of instructions that in response to being executed by circuitry of a processor SoC cause the circuitry to receive a request via a first link or a second link to read debug and/or diagnostic data gathered from one or more registers maintained on the processor SoC. The instructions can also cause the circuitry to determine whether the debug and/or diagnostic data to be read is protected or non-protected. For non-protected debug and/or diagnostic data, the instructions can also cause the circuitry to verify that a requester for the request is allowed to read the gathered debug and/or diagnostic data, and enable the requester to read the gathered debug and/or diagnostic data if the requester is verified. For protected debug and/or diagnostic data, the instructions can also cause the circuitry to encrypt the gathered debug and/or diagnostic data, and enable the requester to read the encrypted gathered debug and/or diagnostic data.
Example 24. The at least one machine readable medium of example 23, the request can be received via the first link and the requester comprises a management controller.
Example 25. The at least one machine readable medium of example 24, wherein the circuitry of the SoC to receive the request from the management controller can be configured to include an interface arranged to couple with the first link. The interface can be configured to operate using management component transport protocols to encapsulate messages described at least in PLDM specifications that include PLDM Base Specification (DSP0240) and PLDM for File Transfer Specification (DSP0242).
Example 26. The at least one machine readable medium of example 25, the instructions can further cause the circuitry to receive the request from the management controller through the interface and cause the management controller to read the gathered debug and/or diagnostic data through the interface.
Example 27. The at least one machine readable medium of example 24, the request can be received via the first link and the circuitry can be an OOBMSM and the requester can be a BMC.
Example 28. The at least one machine readable medium of example 23, the request can be received via the second link and the requester can be a BIOS or a host OS.
Example 29. The at least one machine readable medium of example 28, wherein the request is received via the second link and the requester can be the BIOS or host OS. The instructions can cause the circuitry to enable the BIOS or host OS to read gathered debug and/or diagnostic data by accessing a MMIO space maintained on the processor SoC through an interface,. The interface can be arranged to operate using protocols described in the PCI Express Base Specification, Revision 7.0.
Example 30. The at least one machine readable medium of example 23, the debug and/or diagnostic data can be determined as protected based on a designer or manufacturer of the processor SoC designating the debug and/or diagnostic data as protected.
Example 31. The at least one machine readable medium of example 30, a cryptographic token can be received from the requester and the cryptographic token can be used to verify the requester before the requester is enabled to read the encrypted gathered debug and/or diagnostic data.
Example 32. The at least one machine readable medium of example 30, the gathered debug and/or diagnostic data is encrypted using a symmetric cryptographic algorithm based on a randomly generated symmetric cryptographic key.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus comprising:
a first interface to couple with a first link;
a second interface to couple with a second link; and
circuitry to:
receive a request through the first interface or the second interface to read debug and/or diagnostic data gathered from one or more registers;
determine whether the debug and/or diagnostic data to be read is protected or non-protected;
for non-protected data, verify that a requester associated with the request is permitted to read the debug and/or diagnostic data, and enable the requester to read the gathered data, wherein the non-protected data comprises non-protected debug and/or diagnostic; and
for protected debug and/or diagnostic data, cause the gathered debug and/or diagnostic data to be encrypted, and enable the requester to read the encrypted gathered debug and/or diagnostic data.

2. The apparatus of claim 1, wherein the request is received through the first interface and the requester comprises a management controller.

3. The apparatus of claim 2, wherein the first interface is configured to operate using management component transport protocols to encapsulate messages described at least in Platform Level Data Model (PLDM) specifications that include PLDM Base Specification (DSP0240) and PLDM for File Transfer Specification (DSP0242).

4. The apparatus of claim 3, comprising circuitry to receive the request from the management controller through the first interface and to cause the management controller to read the gathered debug and/or diagnostic data through the first interface.

5. The apparatus of claim 1, wherein the verify that the requester associated with the request is permitted to read the debug and/or diagnostic data comprises access an allow list that is to specify whether the requester is permitted or not permitted to read the debug and/or diagnostic data.

6. The apparatus of claim 1, wherein the request is received through the second interface and the requester comprises a basic input/out system (BIOS) or a host operating system (OS).

7. The apparatus of claim 6, wherein the second interface is configured to operate using protocols described in Peripheral Component Interconnect Express (PCIe) Base Specification, Revision 7.0.

8. The apparatus of claim 7, wherein to enable the BIOS or host OS to read gathered debug and/or diagnostic data comprises the BIOS or host OS enabled to access a memory mapped input/output (MMIO) space through the second interface to read the gathered debug and/or diagnostic data.

9. The apparatus of claim 1, wherein the debug and/or diagnostic data is determined as protected based on a designer or manufacturer of a processor SoC designating the debug and/or diagnostic data as protected.

10. The apparatus of claim 9, wherein a cryptographic token is received from the requester and the cryptographic token is used to verify the requester before the requester is enabled to read the encrypted gathered debug and/or diagnostic data.

11. The apparatus of claim 9, wherein the gathered debug and/or diagnostic data is encrypted comprises data encrypted using a symmetric cryptographic algorithm based on a randomly generated symmetric cryptographic key.

12. A method comprising:
receiving, at circuitry of a processor system on a chip (SoC), a request via a first link or a second link to read debug and/or diagnostic data gathered from one or more registers maintained on the processor SoC;
determining whether the debug and/or diagnostic data to be read is protected or non-protected; and
for non-protected debug and/or diagnostic data, verifying that a requester for the request is permitted to read the gathered debug and/or diagnostic data, and enabling the requester to read the gathered debug and/or diagnostic data if the requester is verified; or
for protected debug and/or diagnostic data, encrypting the gathered debug and/or diagnostic data and enabling the requester to read the encrypted gathered debug and/or diagnostic data.

13. The method of claim 12, wherein the circuitry comprises an out-of-band management service module (OOBMSM) and the requester comprises a baseboard management controller (BMC).

14. The method of claim 12, wherein the requester comprises a basic input/out system (BIOS) or a host operating system (OS), and comprising:
enabling the BIOS or host OS to read gathered debug and/or diagnostic data by accessing a memory mapped input/output (MMIO) space maintained on the processor SoC through an interface to read the gathered debug and/or diagnostic data.

15. The method of claim 12, wherein the debug and/or diagnostic data is determined as protected based on a designer or manufacturer of the processor SoC designating the debug and/or diagnostic data as protected, and wherein the gathered debug and/or diagnostic data is encrypted using a symmetric cryptographic algorithm.

16. At least one machine readable medium comprising a plurality of instructions that in response to being executed by circuitry of a processor system on a chip (SoC) cause the circuitry to:
receive a request via a first link or a second link to read debug and/or diagnostic data gathered from one or more registers maintained on the processor SoC;
determine whether the debug and/or diagnostic data to be read is protected or non-protected; and
for non-protected debug and/or diagnostic data, verify that a requester associated with the request is permitted to read the debug and/or diagnostic data, and enable the requester to read the gathered debug and/or diagnostic data if the requester is verified; and
for protected debug and/or diagnostic data, cause the gathered debug and/or diagnostic data to be encrypted, and enable the requester to read the encrypted gathered debug and/or diagnostic data.

17. The at least one machine readable medium of claim 16, wherein the request is received via the first link, and wherein the circuitry comprises an out-of-band management service module (OOBMSM) and the requester comprises a baseboard management controller (BMC).

18. The at least one machine readable medium of claim 16, wherein the request is received via the second link and the requester comprises a basic input/out system (BIOS) or a host operating system (OS), and wherein the instructions to cause the circuitry to enable the BIOS or host OS to read gathered debug and/or diagnostic data by accessing a memory mapped input/output (MMIO) space maintained on the processor SoC through an interface.

19. The at least one machine readable medium of claim 16, wherein the debug and/or diagnostic data is determined as protected based on a designer or manufacturer of the processor SoC designating the debug and/or diagnostic data as protected.

20. The at least one machine readable medium of claim 19, wherein the gathered debug and/or diagnostic data is encrypted using a symmetric cryptographic algorithm based on a randomly generated symmetric cryptographic key.
